(19) United States
(12) Patent Application Publication
(10) Pub. No.: US 2023/0385618 A1
(43) Pub. Date: Nov. 30, 2023

(54) SPIKE NEURAL NETWORK CIRCUIT INCLUDING INPUT SPIKE DETECTING CIRCUIT AND OPERATING METHOD THEREOF

(71) Applicant: Electronics and Telecommunications Research Institute, Daejeon (KR)

(72) Inventors: Kwang IL OH, Daejeon (KR); Byung-Do YANG, Daejeon (KR); Dongwon LEE, Daejeon (KR); Jae-Jin LEE, Daejeon (KR)

(73) Assignee: Electronics and Telecommunications Research Institute, Daejeon (KR)

(21) Appl. No.: 18/307,196

(22) Filed: Apr. 26, 2023

(30) Foreign Application Priority Data
May 24, 2022 (KR) 10-2022-0063287

(51) Int. Cl. G06N 3/049; G06N 3/063

(52) U.S. Cl. CPC G06N 3/049; G06N 3/063

(57) ABSTRACT

Disclosed is a spike neural network circuit including a synaptic circuit including synapses arranged in rows and columns, an axon circuit that generates a first input spike signal to be provided to a first row among the rows, and a second input spike signal to be provided to a second row among the rows, an input spike detecting circuit that generates an enable signal when detecting a pulse from at least one of the first input spike signal and the second input spike signal, and a first neuron circuit that compares a voltage level of a first accumulated signal, which is output from a first column among the columns, with a threshold voltage level in response to the enable signal, and outputs a first output spike signal when the voltage level of the first accumulated signal exceeds the threshold voltage level.

### CROSS-REFERENCE TO RELATED APPLICATIONS

This application claims priority under 35 U.S.C. § 119 to Korean Patent Application No. 10-2022-0063287 filed on May 24, 2022, in the Korean Intellectual Property Office, the disclosures of which are incorporated by reference herein in their entireties.

### BACKGROUND

Embodiments of the present disclosure described herein relate to a spike neural network circuit, and more particularly, relate to a spike neural network circuit including an input spike detecting circuit.

An artificial neural network (ANN) may process data or information in a method similar to a method of a biological neural network. Unlike a perceptron-based neural network or a convolution-based neural network, in a spike neural network, a spike signal including a pulse toggling during a short time may be used instead of using a signal of a specific level.

Regardless of whether each of a plurality of input spike signals has a pulse, a conventional spike neural network may always compare a voltage of an accumulated signal and a threshold voltage and may generate an output spike signal when the voltage of the accumulated signal exceeds the threshold voltage. That is, the comparison operation of the conventional spike neural network may cause continuous power consumption. Accordingly, there is a need for a method of reducing the power consumption of the comparison operations performed regardless of whether each of a plurality of input spike signals has a pulse.

### SUMMARY

Embodiments of the present disclosure provide a spike neural network circuit including an input spike detecting circuit.

According to an embodiment, a spike neural network circuit includes a synaptic circuit including synapses arranged in a plurality of rows and a plurality of columns, an axon circuit that generates a first input spike signal to be provided to a first row among the plurality of rows, and a second input spike signal to be provided to a second row among the plurality of rows, an input spike detecting circuit that generates an enable signal when detecting a pulse from at least one of the first input spike signal and the second input spike signal, and a first neuron circuit that compares a voltage level of a first accumulated signal, which is output from a first column among the plurality of columns, with a threshold voltage level in response to the enable signal, and outputs a first output spike signal when the voltage level of the first accumulated signal exceeds the threshold voltage level.

According to an embodiment, the input spike detecting circuit may include a first PMOS transistor connected between a power supply node receiving a power supply voltage and a first node and having a gate node connected to a ground node having a ground voltage, a first NMOS transistor connected between the first node and the ground node and operating in response to the first input spike signal, a second NMOS transistor connected between the first node and the ground node and operating in response to the second input spike signal, and a first inverter connected between the first node and a second node and outputting the enable signal to the second node.

According to an embodiment, the first neuron circuit may include a second PMOS transistor connected between a power supply node receiving a power supply voltage and a third node and having a gate node connected to the third node, a third NMOS transistor connected between the third node and a fourth node and operating in response to a threshold signal having the threshold voltage, a fourth NMOS transistor connected between the fourth node and a fifth node and operating in response to a bias signal, a fifth NMOS transistor connected between the fifth node and a ground node receiving a ground voltage and operating in response to the enable signal, a third PMOS transistor connected between the power supply node and a sixth node and having a gate node connected to the third node, a sixth NMOS transistor connected between the sixth node and the fourth node and having a gate node connected to a membrane node, a fourth PMOS transistor connected between the power supply node and a seventh node and having a gate node connected to the sixth node, a seventh NMOS transistor connected between the seventh node and an eighth node and operating in response to the bias signal, and an eighth NMOS transistor connected between the eighth node and the ground node and operating in response to the enable signal.

In an embodiment, the first neuron circuit may further include a ninth NMOS transistor connected between the seventh node and the ground node and operating in response to an inverted enable signal and a second inverter connected between a second node receiving the enable signal and a gate node of the ninth NMOS transistor and outputting the inverted enable signal.

In an embodiment, the first neuron circuit may further include a fifth PMOS transistor connected between the power supply node and a ninth node and having a gate node connected to the seventh node, a tenth NMOS transistor connected between the ninth node and the ground node and having a gate node connected to the seventh node, a sixth PMOS transistor connected between the power supply node and a tenth node and having a gate node connected to the ninth node, an eleventh NMOS transistor connected between the tenth node and an eleventh node and having a gate node connected to the ninth node, a twelfth NMOS transistor connected between the eleventh node and the ground node and operating in response to a reference signal, a reference capacitor connected between the tenth node and the ground node, a seventh PMOS transistor connected between the power supply node and a membrane node and having a gate node connected to the ninth node, and a thirteenth NMOS transistor connected between the membrane node and the ground node. A voltage level of the membrane node may be the same as the voltage level of the first accumulated signal.

In an embodiment, the input spike detecting circuit may be further configured to generate the enable signal by performing an OR operation on the first input spike signal and the second input spike signal.

In an embodiment, a first synapse located in the first column may be further configured to generate a first operation signal by performing an operation of the first input spike signal and a first weight signal. A second synapse located in the first column may be further configured to generate a second operation signal by performing an operation of the second input spike signal and a second weight signal. The first neuron circuit may be further configured to generate the first accumulated signal by accumulating a charge amount of the first operation signal and a charge amount of the second operation signal.

In an embodiment, a third synapse located in a second column among the plurality of columns may generate a third operation signal by performing a third operation of the first input spike signal and a third weight signal. A fourth synapse located in the second column may generate a fourth operation signal by performing a fourth operation of the second input spike signal and a fourth weight signal. The spike neural network circuit may further include a second neuron circuit that compares a voltage level of a second accumulated signal output from the second column with the threshold voltage level in response to the enable signal, and generates a second output spike signal when the voltage level of the second accumulated signal exceeds the threshold voltage level.

According to an embodiment, an operating method of a spike neural network circuit includes generating a first input spike signal, generating a second input spike signal, determining whether at least one of the first input spike signal and the second input spike signal has a pulse, generating an enable signal when it is determined that at least one of the first input spike signal and the second input spike signal has a pulse, comparing a voltage level of an accumulated signal with a threshold voltage level in response to the enable signal, and generating an output spike signal when the voltage level of the accumulated signal exceeds the threshold voltage level.

In an embodiment, the comparing of the voltage level of the accumulated signal with the threshold voltage level in response to the enable signal may include generating a first operation signal by performing a first operation of the first input spike signal and a first weight signal, generating a second operation signal by performing a second operation of the second input spike signal and a second weight signal, and generating the accumulated signal by accumulating a charge amount of the first operation signal and a charge amount of the second operation signal.

### BRIEF DESCRIPTION OF THE FIGURES

The above and other objects and features of the present disclosure will become apparent by describing in detail embodiments thereof with reference to the accompanying drawings.

FIG. 1 is a block diagram showing a general spike neural network circuit, according to an embodiment.

FIG. 2 is a block diagram illustrating a spike neural network circuit, according to an embodiment of the present disclosure.

FIG. 3 is a circuit diagram illustrating the input spike detecting circuit of FIG. 2, according to an embodiment of the present disclosure.

FIG. 4 is a diagram schematically showing synapses of the synaptic circuit of FIG. 2 and neurons of the neuron circuit, according to an embodiment of the present disclosure.

FIG. 5 is a circuit diagram illustrating a general neuron circuit.

FIG. 6 is a circuit diagram illustrating the neuron circuit of FIG. 2, according to an embodiment of the present disclosure.

FIG. 7 is a graph illustrating a first input spike signal, a second input spike signal, an enable signal, and a first output spike signal of the spike neural network circuit of FIG. 2, according to an embodiment of the present disclosure.

FIG. 8 is a flowchart illustrating an operating method of the spike neural network circuit of FIG. 2, according to an embodiment of the present disclosure.

### DETAILED DESCRIPTION

Below, embodiments of the present disclosure will be described in detail and clearly to such an extent that an ordinary one in the art easily implements the present disclosure.

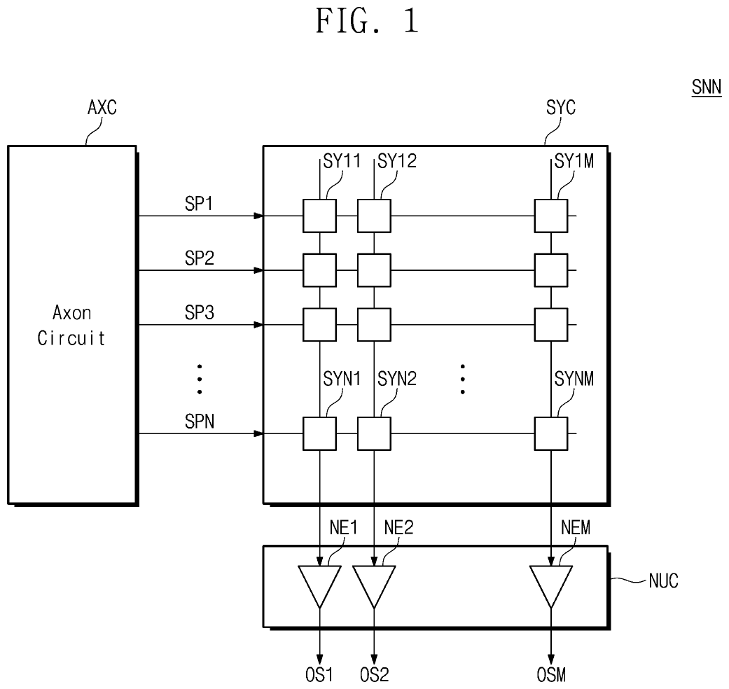

FIG. 1 is a block diagram showing a spike neural network circuit, according to an embodiment. Referring to FIG. 1, a spike neural network circuit SNN may include an axon circuit AXC, a synaptic circuit SYC, and a neuron circuit NUC.

The axon circuit AXC may include axons that generate first to N-th input spike signals SP1 to SPN. Similarly to an axon of a biological neural network, an axon of the axon circuit AXC may output a signal to another neuron. ‘N’ is a natural number.

For example, axons of the axon circuit AXC may generate corresponding first to N-th input spike signals SP1 to SPN based on data or information input from the outside to the spike neural network circuit SNN, respectively. Each of the first to N-th input spike signals SP1 to SPN may be a pulse signal that toggles during a short time. The axon circuit AXC may output the first to N-th input spike signals SP1 to SPN to the synaptic circuit SYC.

The synaptic circuit SYC may connect the axon circuit AXC to the neuron circuit NUC. The synaptic circuit SYC may include a plurality of synapses SY11 to SYNM that determine whether axons of the axon circuit AXC are connected to the neurons of the neuron circuit NUC, and the strength of the connection. Each of the plurality of synapses SY11 to SYNM may have a unique weight value.

Referring to FIG. 1, it is illustrated that the plurality of synapses SY11 to SYNM are positioned on a two-dimensional array. The first to N-th input spike signals SP1 to SPN may be transmitted in a first direction from the axon circuit AXC to the synaptic circuit SYC. Operation signals (i.e., an operation result) obtained by applying weight values to the first to N-th input spike signals SP1 to SPN may be transmitted in a second direction from the synaptic circuit SYC to the neuron circuit NUC. For example, the first direction and the second direction may be perpendicular to each other.

The plurality of synapses SY11 to SYNM may receive the corresponding first to N-th input spike signals SP1 to SPN. For example, the synapse SY11, the synapse SY12, and the synapse SY1M that are located in a first row among the plurality of synapses SY11 to SYNM may receive the first input spike signal SP1. The synapse SYN1, the synapse SYN2, and the synapse SYNM located in an N-th row among the plurality of synapses SY11 to SYNM may receive the N-th input spike signal SPN. “M” is a natural number.

Each of the plurality of synapses SY11 to SYNM may perform a multiplication operation by applying weight values to the first to N-th input spike signals SP1 to SPN. The weight values may be numerical values indicating a correlation between an axon and a neuron, the strength of connections between axons of the axon circuit AXC and neurons of the neuron circuit NUC, and a correlation between a neuron of the neuron circuit NUC and the input spike signal, as described above.

For example, the synapse SY11 located in the first row may apply a first weight value to the first input spike signal SP1. The synapse SY21 located in the second row may apply a second weight value to the second input spike signal SP2. The synapse SYN1 located in the N-th row may apply an N-th weight value to the N-th input spike signal SPN. Each of the plurality of synapses SY11 to SYNM may perform an arithmetic operation based on an input spike signal and a weight value and then may output an operation signal to the neuron circuit NUC.

First to M-th neurons NE1 to NEM of the neuron circuit NUC may receive operation signals obtained by applying weight values to input spike signals in the synaptic circuit SYC, respectively. Similarly to dendrites in a biological neural network, each of the first to M-th neurons NE1 to NEM may receive a signal output from another neuron.

Referring to FIG. 1, each of the first to M-th neurons NE1 to NEM may be connected to the plurality of synapses SY11 to SYNM arranged in the second direction and may receive operation signals output from the plurality of synapses SY11 to SYNM. The operation signals of the plurality of synapses SY11 to SYNM arranged in the second direction may be accumulated in each of the first to M-th neurons NE1 to NEM.

In more detail, the first neuron NE1 may receive operation signals output from the plurality of synapses SY11 to SYN1 located in a first column. The second neuron NE2 may receive operation signals output from the plurality of synapses SY12 to SYN2 located in a second column. The M-th neuron NEM may receive operation signals output from the plurality of synapses SY1M to SYNM located in an M-th column. However, the number and arrangement of the plurality of synapses SY11 to SYNM connected to the first to M-th neurons NE1 to NEM are not limited to those illustrated in FIG. 1.

The first to M-th neurons NE1 to NEM may generate first to M-th accumulated signals by accumulating operation signals of the plurality of synapses SY11 to SYNM. Each of the first to M-th neurons NE1 to NEM may compare a voltage level of each of the first to M-th accumulated signals with a voltage level of the threshold signal. When the voltage level of each of the first to M-th accumulated signals exceeds the voltage level of the threshold signal, the first to M-th neurons NE1 to NEM may generate output spike signals OS1 to OSM, respectively. That is, the first to M-th neurons NE1 to NEM may generate pulses in response to voltages of the first to M-th neuron signals reaching the threshold voltage, respectively (i.e., the first to M-th neurons NE1 to NEM may fire).

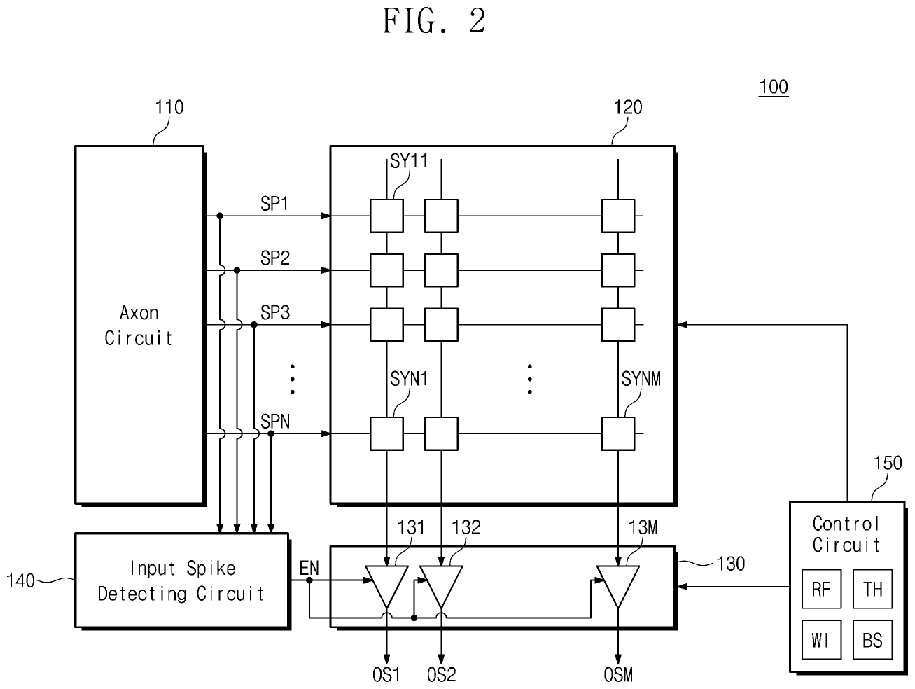

FIG. 2 is a block diagram illustrating a spike neural network circuit, according to an embodiment of the present disclosure. Referring to FIG. 2, a spike neural network circuit 100 may include an axon circuit 110, a synaptic circuit 120, a neuron circuit 130, an input spike detecting circuit 140, and a control circuit 150. The axon circuit 110, the synaptic circuit 120, and the neuron circuit 130 may correspond to the axon circuit AXC, the synaptic circuit SYC, and the neuron circuit NUC of FIG. 1, respectively.

The spike neural network circuit 100 may perform a comparison operation based on whether each of the first to N-th input spike signals SP1 to SPN has a pulse. The comparison operation may indicate that the spike neural network circuit 100 compares a voltage level of each of the first to M-th accumulated signals with a threshold voltage level and outputs first to M-th output spike signals.

The neuron circuit 130 may include first to M-th neurons 131 to 13M. The first neuron 131 may compare a threshold voltage level with a voltage level of a first accumulated signal, which is generated by accumulating charge amounts of operation signals of each of the plurality of synapses SY11 to SYN1 located in a first column, in response to an enable signal EN. The enable signal EN may indicate whether at least one of the plurality of input spike signals SP1 to SPN has a pulse.

In an embodiment, the first neuron 131 may compare the voltage of the first accumulated signal with a threshold voltage in response to the enable signal EN. The second neuron 132 may compare the voltage of the second accumulated signal with the threshold voltage in response to the enable signal EN. The M-th neuron 13M may compare the voltage of the M-th accumulated signal with the threshold voltage in response to the enable signal EN.

In more detail, when receiving the enable signal EN having a first logic level, the first neuron 131 may compare the voltage level of the first accumulated signal with the threshold voltage level. When receiving the enable signal EN having a second logic level, the first neuron 131 may not compare the voltage level of the first accumulated signal with the threshold voltage level. In an embodiment, the first logic level may be a logic high level, and the second logic level may be a logic low level.

When the voltage level of the first accumulated signal exceeds the threshold voltage level, the first neuron 131 may output the first output spike signal OS1. When the voltage level of the second accumulated signal exceeds the threshold voltage level, the second neuron 132 may output the second output spike signal OS2. When the voltage level of the M-th accumulated signal exceeds the threshold voltage level, the M-th neuron 13M may output the M-th output spike signal OSM.

The input spike detecting circuit 140 may generate the enable signal EN by detecting a pulse from at least one of the first to N-th input spike signals SP1 to SPN.

In an embodiment, the input spike detecting circuit 140 may generate the enable signal EN by performing an OR operation on the first to N-th input spike signals SP1 to SPN.

In an embodiment, when detecting a pulse from at least one of the first to N-th input spike signals SP1 to SPN, the input spike detecting circuit 140 may generate the enable signal EN having a first logic level. When not detecting a pulse from at least one of the first to N-th input spike signals SP1 to SPN, the input spike detecting circuit 140 may generate the enable signal EN having a second logic level.

The control circuit 150 may generate signals necessary for operations of the synaptic circuit 120 and the neuron circuit 130. The control circuit 150 may generate a weight signal WI, a reference signal RF, a threshold signal TH, and a bias signal BS. The weight signal WI may include information about a weight value of each of the plurality of synapses SY11 to SYNM. The reference signal RF may control a resting period of the first neuron 131. The threshold signal TH may be a target of a comparison operation of the spike neural network circuit 100. The bias signal BS may provide a voltage necessary for the neuron circuit 130 to perform the comparison operation.

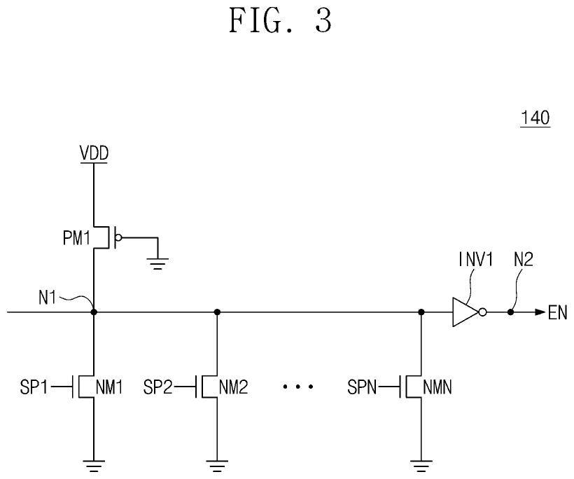

FIG. 3 is a circuit diagram illustrating the input spike detecting circuit of FIG. 2, according to an embodiment of the present disclosure. Referring to FIGS. 2 and 3, the input spike detecting circuit 140 may include a first PMOS transistor PM1 and a plurality of NMOS transistors NM1 to NMN.

The input spike detecting circuit 140 may include the first PMOS transistor PM1 connected between a first node N1 and a power supply node receiving the power supply voltage VDD. A gate node of the first PMOS transistor PM1 may be connected to a ground node receiving a ground voltage. As the gate node of the first PMOS transistor PM1 is connected to the ground node, the first PMOS transistor PM1 may always be turned on. The first PMOS transistor PM1 may be a pull-up transistor.

The input spike detecting circuit 140 may include the plurality of NMOS transistors NM1 to NMN respectively corresponding to the plurality of input spike signals SP1 to SPN. Each of the plurality of NMOS transistors NM1 to NMN may be a pull-down transistor. The plurality of NMOS transistors NM1 to NMN may be connected to one another in parallel.

The first NMOS transistor NM1 may be connected between the first node N1 and the ground node to operate in response to the first input spike signal SP1. The first NMOS transistor NM1 may be turned on based on a pulse of the first input spike signal SP1. In this case, the voltage of the first node N1 may be a ground voltage.

The second NMOS transistor NM2 may be connected between the first node N1 and the ground node to operate in response to the second input spike signal SP2. The N-th NMOS transistor NMN may operate in response to the N-th input spike signal SPN.

When at least one NMOS transistor among the plurality of NMOS transistors NM1 to NMN is turned on, the first node N1 may have a ground voltage (i.e., a logic low level). The input spike detecting circuit 140 may perform an OR operation of the plurality of input spike signals SP1 to SPN through the plurality of NMOS transistors NM1 to NMN.

The input spike detecting circuit 140 may include a first inverter INV1 connected between the first node N1 and a second node N2 outputting the enable signal EN. The first inverter INV1 may output the enable signal EN. When the first node N1 has a second logic level, the first inverter INV1 may output the enable signal EN having a first logic level.

As described above, the input spike detecting circuit 140 may generate the enable signal EN by detecting a pulse from at least one of the first to N-th input spike signals SP1 to SPN.

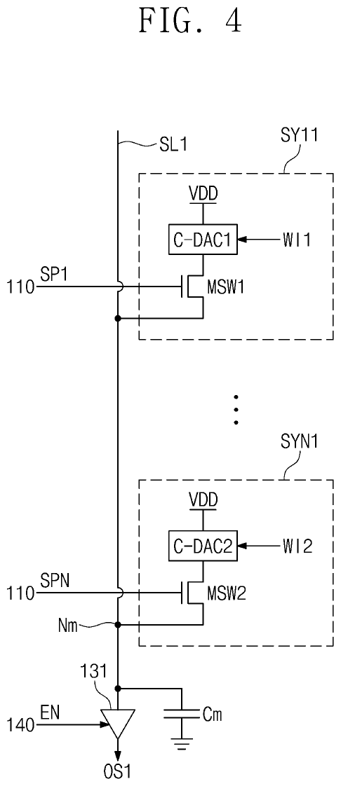

FIG. 4 is a diagram schematically showing synapses of the synaptic circuit of FIG. 2 and neurons of the neuron circuit, according to an embodiment of the present disclosure. Referring to FIGS. 2 and 4, the synapses SY11 to SYN1 located in a first column of the synaptic circuit SYC in FIG. 2 and the first neuron 131 are shown.

The first synapse SY11 may include a first converter C-DAC1 and a first synapse transistor MSW1. The first synapse SY11 may generate a first operation signal based on the first input spike signal SP1 and a first weight value WI1. The voltage of the first operation signal may be determined by the product of the first input spike signal SP1 and the first weight value WI1. The first synapse SY11 may output the first operation signal to a first transmission line SL1.

The N-th synapse SYN1 may be implemented in the same method as the first synapse SY11. The N-th synapse SYN1 may include a second converter C-DAC2 and a second synapse transistor MSW2. The N-th synapse SYN1 may generate a second operation signal based on a weight value WI2 of the N-th synapse SYN1 and the N-th input spike signal SPN. The N-th synapse SYN1 may output the second operation signal to the first transmission line SL1.

A membrane capacitor Cm may accumulate charges by the first operation signal output from the first synapse SY11 and the second operation signal output from the N-th synapse SYN1. The membrane capacitor Cm may be charged by currents, which are output from the first to N-th synapses SY11 to SYN1 and which correspond to weight values. A voltage of a membrane node Nm may be a value obtained by accumulating currents output from the first to N-th synapses SY11 to SYN1. The voltage of the membrane node Nm may be a value determined by weight values output from first to N-th the synapses SY11 to SYN1. The voltage of the membrane node Nm may be provided to the first neuron 131.

The first neuron 131 may compare a voltage level of the membrane node Nm with a voltage level of the threshold signal in response to the enable signal EN having the first logic level. The first neuron 131 may generate the first output spike signal OS1 based on the comparison result. In an embodiment, when the voltage level of the membrane node Nm exceeds the voltage level of the threshold signal, the first neuron 131 may generate the first output spike signal OS1.

Regardless of whether each of the input spike signals has a pulse, the general neuron circuit NUC disclosed in FIG. 1 may continuously perform a comparison operation. Accordingly, a general spike neural network circuit SNN may continuously consume power. However, the neuron circuit 130 according to an embodiment of the present disclosure may perform a comparison operation based on whether each of the input spike signals has a pulse. In other words, the spike neural network circuit 100 according to an embodiment of the present disclosure may perform a comparison operation by consuming less power than the general spike neural network circuit.

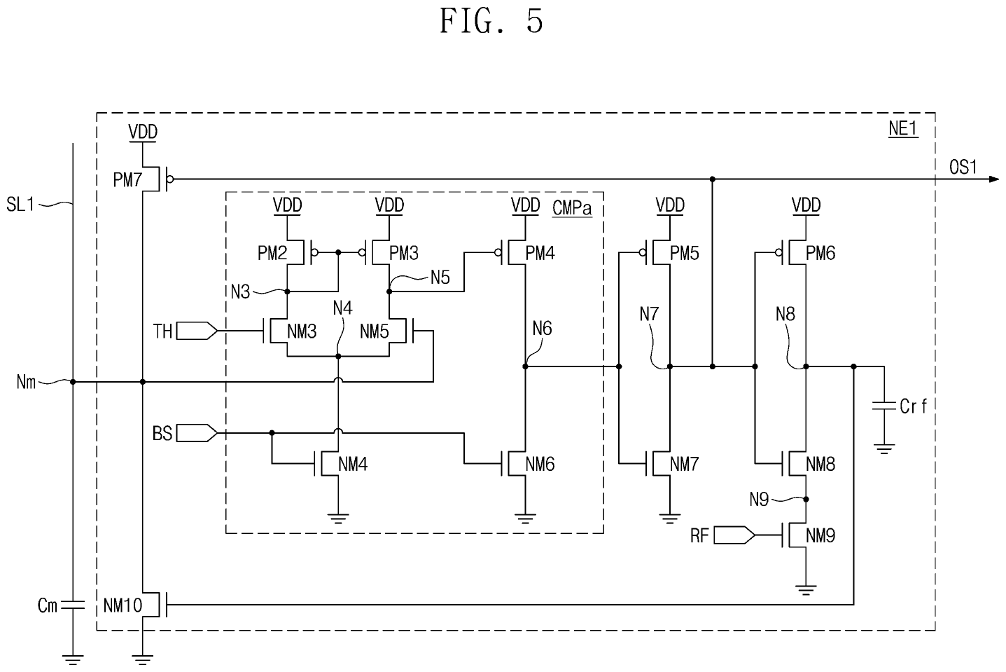

FIG. 5 is a circuit diagram illustrating a general neuron circuit. Referring to FIG. 5, a structure of a first neuron NE1 in FIG. 1 is shown.

The first neuron NE1 may include a comparison circuit CMPa. The comparison circuit CMPa may continuously compare a voltage of the membrane node Nm with a voltage of the threshold signal TH. The comparison circuit CMPa may include second to fourth PMOS transistors PM2 to PM4 and third to sixth NMOS transistors NM3 to NM6.

The second PMOS transistor PM2 may be connected between a power supply node having the power supply voltage VDD and a third node N3, and may have a gate node connected to the third node N3. The third NMOS transistor NM3 may be connected between the third node N3 and a fourth node N4 to operate in response to the threshold signal TH. The fourth NMOS transistor NM4 may be connected between the fourth node N4 and a ground node having a ground voltage to operate in response to the bias signal BS.

The third PMOS transistor PM3 may be connected between the power supply node and a fifth node N5 and may have a gate node connected to the third node N3. The fifth NMOS transistor NM5 may be connected between the fifth node N5 and the fourth node N4 and may have a gate node connected to the membrane node Nm.

The fourth PMOS transistor PM4 may be connected between the power supply node and a sixth node N6 and may have a gate node connected to the fifth node N5. The sixth NMOS transistor NM6 may be connected between the sixth node N6 and the ground node to operate in response to the bias signal BS.

The bias signal BS may be a signal for providing the comparison circuit CMPa with current for a comparison operation. As the fourth NMOS transistor NM4 and the sixth NMOS transistor NM6 are turned on in response to the bias signal BS, the comparison circuit CMPa may continuously compare the voltage of the membrane node Nm with the voltage of the threshold signal TH. Accordingly, the comparison circuit CMPa may continuously consume power.

The first neuron NE1 may further include fifth to seventh PMOS transistors PM5 to PM7, seventh to tenth NMOS transistors NM7 to NM10, and a reference capacitor Crf.

The fifth PMOS transistor PM5 may be connected between the power supply node and a seventh node N7, and may have a gate node connected to the sixth node N6. The seventh NMOS transistor NM7 may be connected between the seventh node N7 and the ground node, and may have a gate node connected to the sixth node N6.

The sixth PMOS transistor PM6 may be connected between the power supply node and an eighth node N8, and may have a gate node connected to the seventh node N7. The eighth NMOS transistor NM8 may be connected between the eighth node N8 and a ninth node N9, and may have a gate node connected to the seventh node N7. The ninth NMOS transistor NM9 may be connected between the ninth node N9 and the ground node to operate in response to the reference signal RF.

The reference signal RF may be a signal for controlling a resting period of the first neuron NE1. In an embodiment, when the first output spike signal OS1 is output, the ninth NMOS transistor NM9 may control the discharge amount of charge charged in the reference capacitor Crf. The reference capacitor Crf may be connected between the eighth node N8 and the ground node. The ninth NMOS transistor NM9 may be turned on in response to the reference signal RF. That is, the discharge amount of charge charged in the reference capacitor Crf may be adjusted based on the reference signal RF. As the first neuron NE1 fires and the tenth NMOS transistor NM10 is turned on, a period (i.e., a resting period) during which a voltage of the membrane node Nm is connected to the ground voltage may be adjusted.

The seventh PMOS transistor PM7 may be connected between the power supply node and the membrane node Nm, and may have a gate node connected to the seventh node N7. The tenth NMOS transistor NM10 may be connected between the membrane node Nm and the ground node, and may have a gate node connected to the eighth node N8.

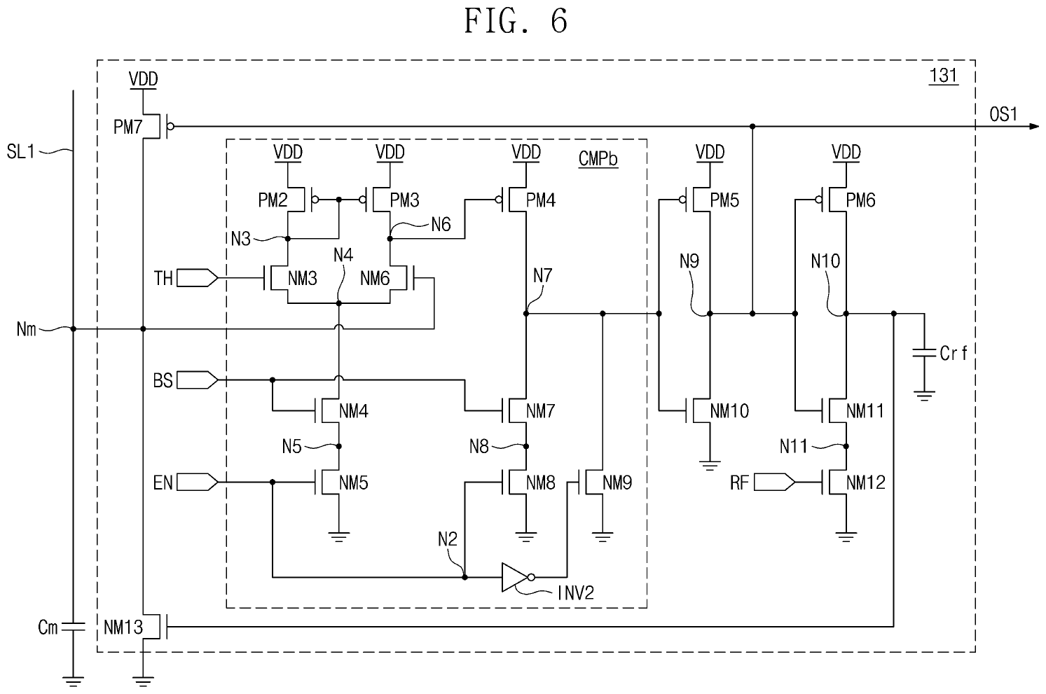

FIG. 6 is a circuit diagram illustrating the neuron circuit of FIG. 2, according to an embodiment of the present disclosure. Referring to FIG. 6, a structure of the first neuron 131 in FIG. 2 is shown.

The first neuron 131 may include a comparison circuit CMPb. The comparison circuit CMPb may compare a voltage of the membrane node Nm and a voltage of the threshold signal TH in response to the enable signal EN having a first logic level. The comparison circuit CMPb may include second to the fourth PMOS transistors PM2 to PM4 and the third to ninth NMOS transistors NM3 to NM9.

The second PMOS transistor PM2 may be connected between a power supply node having the power supply voltage VDD and the third node N3, and may have a gate node connected to the third node N3. The third NMOS transistor NM3 may be connected between the third node N3 and the fourth node N4 to operate in response to the threshold signal TH. The fourth NMOS transistor NM4 may be connected between the fourth node N4 and the fifth node N5 to operate in response to the bias signal BS. The fifth NMOS transistor NM5 may be connected between the fifth node N5 and the ground node to operate in response to the enable signal EN.

The third PMOS transistor PM3 may be connected between the power supply node and the sixth node N6, and may have a gate node connected to the third node N3. The sixth NMOS transistor NM6 may be connected between the sixth node N6 and the fourth node N4 and may have a gate node connected to the membrane node Nm.

The fourth PMOS transistor PM4 may be connected between the power supply node and the seventh node N7 and may have a gate node connected to the sixth node N6. The seventh NMOS transistor NM7 may be connected between the seventh node N7 and the eighth node N8 to operate in response to the bias signal BS. The eighth NMOS transistor NM8 may be connected between the eighth node N8 and the ground node to operate in response to the enable signal EN. A second inverter INV2 may be connected between the second node N2 and a gate node of the ninth NMOS transistor NM9. The second node N2 may be connected to gate nodes of the fifth NMOS transistor NM5 and the eighth NMOS transistor NM8. The ninth NMOS transistor NM9 may be connected between the seventh node N7 and the ground node, and may have a gate node connected to the output node of the second inverter INV2.

As the third NMOS transistor NM3 operates in response to the threshold signal TH, and the sixth NMOS transistor NM6 operates in response to the signal of the membrane node Nm, the third NMOS transistor NM3 and the sixth NMOS transistor NM6 may serve as a switch for performing a comparison operation of the comparison circuit CMPb.

The second PMOS transistor PM2 and the third PMOS transistor PM3 may increase an amplification rate of the comparison circuit CMPb by providing high impedance to a load stage of the comparison circuit CMPb.

The comparison operation of the comparison circuit CMPb may be controlled by the enable signal EN. In more detail, when receiving the enable signal EN having the first logic level, the fifth NMOS transistor NM5 and the eighth NMOS transistor NM8 may be turned on, and thus the comparison circuit CMPb may perform a comparison operation between the voltage of the threshold signal TH and the voltage of the membrane node Nm.

When receiving the enable signal EN having a second logic level, the fifth NMOS transistor NM5 and the eighth NMOS transistor NM8 may be turned off, and the ninth NMOS transistor NM9 may be turned on. Accordingly, a bias current flowing through the fourth NMOS transistor NM4 and the seventh NMOS transistor NM7 may be blocked, and the comparison circuit CMPb may not perform the comparison operation between the voltage of the threshold signal TH and the voltage of the membrane node Nm.

To prevent the seventh node N7 from being maintained as a floating node, the ninth NMOS transistor NM9 may pull down the seventh node N7 to a ground voltage.

As described above, the comparison circuit CMPb may perform the comparison operation in response to the enable signal EN having the first logic level, and thus the comparison circuit CMPb may consume less power, unlike the comparison circuit CMPa performing a continuous comparison operation shown in FIG. 5.

The first neuron 131 may further include the fifth to seventh PMOS transistors PM5 to PM7, tenth to thirteenth NMOS transistors NM10 to NM13, and the reference capacitor Crf.

The fifth PMOS transistor PM5 may be connected between the power supply node and the ninth node N9, and may have a gate node connected to the seventh node N7. The tenth NMOS transistor NM10 may be connected between the ninth node N9 and the ground node, and may have a gate node connected to the seventh node N7. An inverter may be configured through the fifth PMOS transistor PM5 and the tenth NMOS transistor NM10.

The sixth PMOS transistor PM6 may be connected between the power supply node and a tenth node N10, and may have a gate node connected to the ninth node N9. The eleventh NMOS transistor NM11 may be connected between the tenth node N10 and an eleventh node N11 and may have a gate node connected to the ninth node N9. The twelfth NMOS transistor NM12 may be connected between the eleventh node N11 and the ground node to operate in response to the reference signal RF.

The reference signal RF may be a signal for controlling a resting period of the first neuron 131. In an embodiment, when the first output spike signal OS1 is output, the twelfth NMOS transistor NM12 may control the discharge amount of charge charged in the reference capacitor Crf. The reference capacitor Crf may be connected between the tenth node N10 and the ground node. The twelfth NMOS transistor NM12 may be turned on in response to the reference signal RF. That is, the discharge amount of charge charged in the reference capacitor Crf is discharged may be adjusted based on the reference signal RF. Accordingly, as the first neuron 131 fires and the thirteenth NMOS transistor NM13 is turned on, a period (i.e., a resting period) during which a voltage of the membrane node Nm is connected to the ground voltage may be adjusted.

The seventh PMOS transistor PM7 may be connected between the power supply node and the membrane node Nm, and may have a gate node connected to the ninth node N9. The thirteenth NMOS transistor NM13 is connected between the membrane node Nm and the ground node, and may have a gate node connected to the tenth node N10.

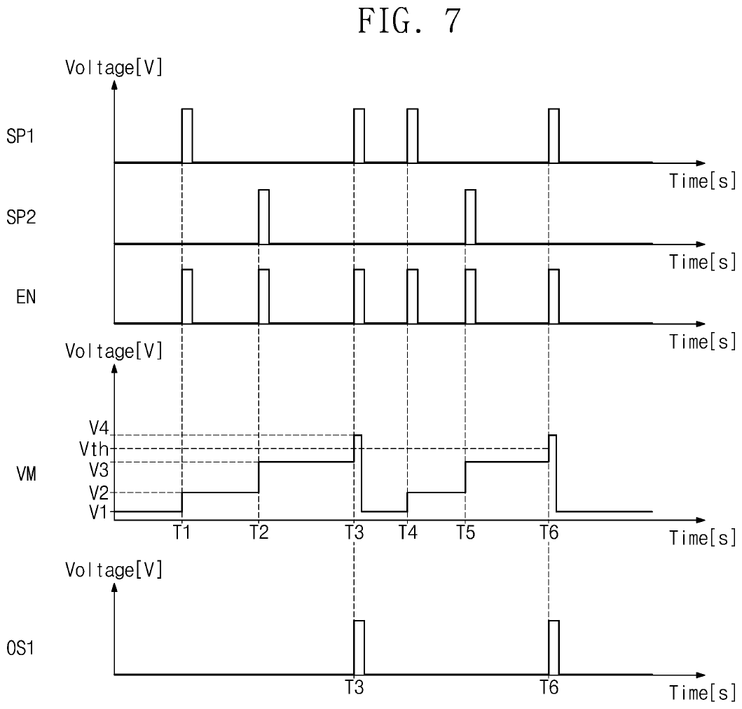

FIG. 7 is a graph illustrating a first input spike signal, a second input spike signal, an enable signal, and a first output spike signal of the spike neural network circuit of FIG. 2, according to an embodiment of the present disclosure. Referring to FIGS. 2, 4, and 7, the first output spike signal OS1 generated based on a first input spike signal SP1, a second input spike signal SP2, and the enable signal EN is shown.

At a first time point T1, the first synapse SY11 may be turned on in response to a pulse of the first input spike signal SP1. The first synapse SY11 may generate a first operation signal based on the first input spike signal SP1 and a first weight of the first synapse SY11. Charges corresponding to the first operation signal may be charged in the membrane capacitor Cm. Accordingly, a voltage VM of the membrane node Nm may rise from a first voltage V1 to a second voltage V2. The first voltage V1 may be the voltage VM of the membrane node Nm at a point in time when there is no charge charged in the membrane capacitor Cm. The first voltage V1 may be a discharge voltage close to a ground voltage.

At the first time point T1, the input spike detecting circuit 140 may generate the enable signal EN by detecting the pulse of the first input spike signal SP1. At the first time point T1, the enable signal EN may have a first logic level.

As the enable signal EN is in the first logic level, the first neuron 131 may compare the voltage VM of the membrane node Nm with a threshold voltage Vth. As the second voltage V2 is less than the threshold voltage Vth, the first neuron 131 may not fire.

At the second time point T2, a second synapse may be turned on in response to the pulse of the second input spike signal SP2. Accordingly, the second synapse may output a second operation signal based on the second input spike signal SP2 and a second weight of the second synapse. Charges corresponding to the second operation signal may be charged in the membrane capacitor Cm. Accordingly, the voltage VM of the membrane node Nm may rise from the second voltage V2 to a third voltage V3.

At the second time point T2, the input spike detecting circuit 140 may generate the enable signal EN by detecting the pulse of the second input spike signal SP2. At the second time point T2, the enable signal EN may have the first logic level.

The first neuron 131 may compare the threshold voltage Vth with the voltage VM of the membrane node Nm in response to the enable signal EN having the first logic level. As the third voltage V3 is less than the threshold voltage Vth, the first neuron 131 may not fire.

At a third time point T3, the first synapse SY11 may be turned on in response to a pulse of the first input spike signal SP1. Accordingly, the first synapse SY11 may output a third operation signal based on the first input spike signal SP1 and the first weight of the first synapse SY11. Charges corresponding to the third operation signal may be charged in the membrane capacitor Cm. Accordingly, a voltage VM of the membrane node Nm may rise from the third voltage V3 to a fourth voltage V4.

At the third time point T3, the input spike detecting circuit 140 may generate the enable signal EN in response to the pulse of the first input spike signal SP1. At the third time point T3, the enable signal EN may have the first logic level.

The first neuron 131 may compare the threshold voltage Vth with the voltage VM of the membrane node Nm in response to the enable signal EN having the first logic level. The first neuron 131 may generate a pulse based on a fact that the fourth voltage V4 is greater than the threshold voltage Vth (i.e., the first neuron 131 may fire). The first neuron 131 may output the first output spike signal OS1. Afterward, the voltage VM of the membrane node Nm may be discharged to the first voltage V1 close to the ground voltage.

An operation at each of the fourth to sixth time points T4 to T6 may be similar to the operation at each of the first to third time points T1 to T3.

As described above, when at least one pulse of the first input spike signal SP1 and the second input spike signal SP2 is detected, the first neuron 131 may compare the threshold voltage Vth with the voltage VM of the membrane node Nm. In other words, when at least one pulse of the first input spike signal SP1 and the second input spike signal SP2 is not detected, the first neuron 131 may not perform a comparison operation between the voltage VM of the membrane node Nm and the threshold voltage Vth, thereby reducing unnecessary power consumption.

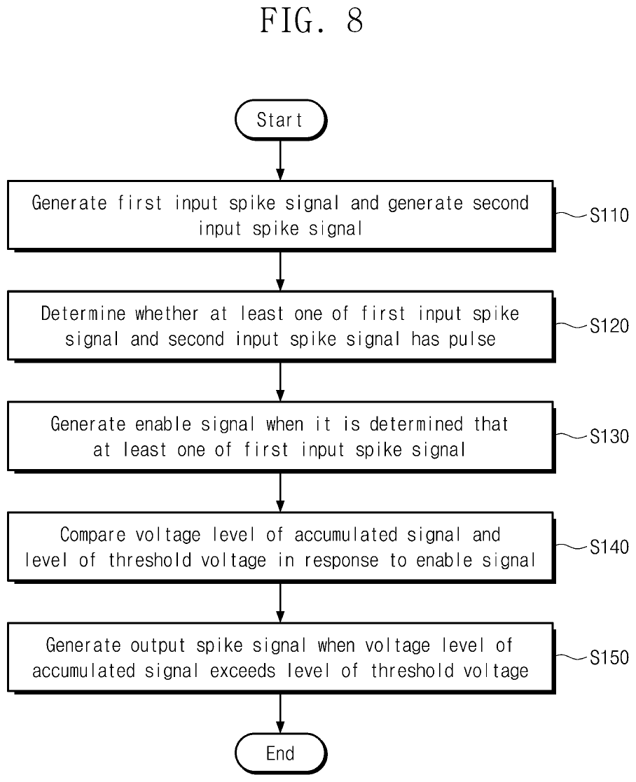

FIG. 8 is a flowchart illustrating an operating method of the spike neural network circuit of FIG. 2, according to an embodiment of the present disclosure. Referring to FIGS. 2 and 8, an operating method of the spike neural network circuit 100 in FIG. 2 is shown.

In operation S110, the spike neural network circuit 100 may generate the first input spike signal SP1. The spike neural network circuit 100 may generate the second input spike signal SP2. However, the present disclosure is not limited thereto. In an embodiment, the spike neural network circuit 100 may generate the first to N-th input spike signals SP1 to SPN.

In operation S120, the spike neural network circuit 100 may determine whether at least one of the first input spike signal SP1 and the second input spike signal SP2 has a pulse.

In operation S130, when it is determined that at least one of the first input spike signal SP1 and the second input spike signal SP2 has a pulse, the spike neural network circuit 100 may generate the enable signal EN. In an embodiment, the enable signal EN may have a first logic level.

In operation S140, the spike neural network circuit 100 may compare the voltage level of the accumulated signal and the level of the threshold voltage in response to the enable signal EN. In an embodiment, operation S140 may include generating, by the spike neural network circuit 100, a first operation signal by performing a first operation on the first input spike signal SP1 and a first weight signal, generating a second operation signal by performing a second operation of the second input spike signal SP2 and a second weight signal, and generating an accumulated signal by accumulating a charge amount of the first operation signal and a charge amount of the second operation signal.

In operation S150, when the voltage level of the accumulated signal exceeds the level of the threshold voltage, the spike neural network circuit 100 may generate an output spike signal.

The above description refers to detailed embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

According to an embodiment of the present disclosure, a spike neural network circuit including an input spike detecting circuit is provided.

According to an embodiment of the present disclosure, a spike neural network circuit capable of reducing a current used to compare a voltage of an accumulated signal with a voltage of a threshold voltage is provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A spike neural network circuit comprising:
a synaptic circuit including synapses arranged in a plurality of rows and a plurality of columns;
an axon circuit configured to generate a first input spike signal to be provided to a first row among the plurality of rows, and a second input spike signal to be provided to a second row among the plurality of rows;
an input spike detecting circuit configured to generate an enable signal when detecting a pulse from at least one of the first input spike signal and the second input spike signal; and
a first neuron circuit configured to:
compare a voltage level of a first accumulated signal, which is output from a first column among the plurality of columns, with a threshold voltage level in response to the enable signal; and
output a first output spike signal when the voltage level of the first accumulated signal exceeds the threshold voltage level.

2. The spike neural network circuit of claim 1, wherein the input spike detecting circuit includes:
a first PMOS transistor connected between a power supply node receiving a power supply voltage and a first node and configured to have a gate node connected to a ground node having a ground voltage;
a first NMOS transistor connected between the first node and the ground node and configured to operate in response to the first input spike signal;
a second NMOS transistor connected between the first node and the ground node and configured to operate in response to the second input spike signal; and
a first inverter connected between the first node and a second node and configured to output the enable signal to the second node.

3. The spike neural network circuit of claim 1, wherein the first neuron circuit includes:
a second PMOS transistor connected between a power supply node receiving a power supply voltage and a third node and configured to have a gate node connected to the third node;
a third NMOS transistor connected between the third node and a fourth node and configured to operate in response to a threshold signal having the threshold voltage;
a fourth NMOS transistor connected between the fourth node and a fifth node and configured to operate in response to a bias signal;
a fifth NMOS transistor connected between the fifth node and a ground node receiving a ground voltage and configured to operate in response to the enable signal;
a third PMOS transistor connected between the power supply node and a sixth node and configured to have a gate node connected to the third node;
a sixth NMOS transistor connected between the sixth node and the fourth node and configured to have a gate node connected to a membrane node;
a fourth PMOS transistor connected between the power supply node and a seventh node and configured to have a gate node connected to the sixth node;
a seventh NMOS transistor connected between the seventh node and an eighth node and configured to operate in response to the bias signal; and
an eighth NMOS transistor connected between the eighth node and the ground node and configured to operate in response to the enable signal.

4. The spike neural network circuit of claim 3, wherein the first neuron circuit further includes:
a ninth NMOS transistor connected between the seventh node and the ground node and configured to operate in response to an inverted enable signal; and
a second inverter connected between a second node receiving the enable signal and a gate node of the ninth NMOS transistor and configured to output the inverted enable signal.

5. The spike neural network circuit of claim 3, wherein the first neuron circuit further includes:
a fifth PMOS transistor connected between the power supply node and a ninth node and configured to have a gate node connected to the seventh node;
a tenth NMOS transistor connected between the ninth node and the ground node and configured to have a gate node connected to the seventh node;
a sixth PMOS transistor connected between the power supply node and a tenth node and configured to have a gate node connected to the ninth node;
an eleventh NMOS transistor connected between the tenth node and an eleventh node and configured to have a gate node connected to the ninth node;
a twelfth NMOS transistor connected between the eleventh node and the ground node and configured to operate in response to a reference signal;
a reference capacitor connected between the tenth node and the ground node;
a seventh PMOS transistor connected between the power supply node and a membrane node and configured to have a gate node connected to the ninth node; and
a thirteenth NMOS transistor connected between the membrane node and the ground node, and
wherein a voltage level of the membrane node is the same as the voltage level of the first accumulated signal.

6. The spike neural network circuit of claim 1, wherein the input spike detecting circuit is further configured to generate the enable signal by performing an OR operation on the first input spike signal and the second input spike signal.

7. The spike neural network circuit of claim 1, wherein a first synapse located in the first column is further configured to generate a first operation signal by performing an operation of the first input spike signal and a first weight signal,
wherein a second synapse located in the first column is further configured to generate a second operation signal by performing an operation of the second input spike signal and a second weight signal, and
wherein the first neuron circuit is further configured to generate the first accumulated signal by accumulating a charge amount of the first operation signal and a charge amount of the second operation signal.

8. The spike neural network circuit of claim 1, wherein a third synapse located in a second column among the plurality of columns generates a third operation signal by performing a third operation of the first input spike signal and a third weight signal,
a fourth synapse located in the second column generates a fourth operation signal by performing a fourth operation of the second input spike signal and a fourth weight signal,
further comprising:
a second neuron circuit configured to:
compare a voltage level of a second accumulated signal output from the second column with the threshold voltage level in response to the enable signal; and
generate a second output spike signal when the voltage level of the second accumulated signal exceeds the threshold voltage level.

9. An operating method of a spike neural network circuit, the method comprising:
generating a first input spike signal;
generating a second input spike signal;
determining whether at least one of the first input spike signal and the second input spike signal has a pulse;
generating an enable signal when it is determined that at least one of the first input spike signal and the second input spike signal has a pulse;
comparing a voltage level of an accumulated signal with a threshold voltage level in response to the enable signal; and
generating an output spike signal when the voltage level of the accumulated signal exceeds the threshold voltage level.

10. The method of claim 9, wherein the comparing of the voltage level of the accumulated signal with the threshold voltage level in response to the enable signal includes:
generating a first operation signal by performing a first operation of the first input spike signal and a first weight signal;
generating a second operation signal by performing a second operation of the second input spike signal and a second weight signal; and
generating the accumulated signal by accumulating a charge amount of the first operation signal and a charge amount of the second operation signal.
